(19) United States
(12) Patent Application Publication
(10) Pub. No.: US 2026/0052368 A1
(43) Pub. Date: Feb. 19, 2026

(54) Methods and Devices for Emergency Service Handling

(71) Applicant: Telefonaktiebolaget LM Ericsson (publ), Stockholm (SE)

(72) Inventors: Juying Gan, Shanghai (CN); Zhang Fu, Stockholm (SE); Shabnam Sultana, Montreal (CA)

(21) Appl. No.: 19/101,700

(22) PCT Filed: Jul. 24, 2023
(86) PCT No.: PCT/EP2023/070431

§ 371 Date: Feb. 6, 2025

(30) Foreign Application Priority Data
Aug. 9, 2022 (WO) PCT/CN2022/111267

(51) Int. Cl. H04W 4/90; H04W 12/06; H04W 12/72; H04W 60/00

(52) U.S. Cl. CPC H04W 4/90; H04W 12/06; H04W 12/72; H04W 60/00

(57) ABSTRACT

A method implemented by a first terminal device is provided. The method comprises: receiving, from a first network node, information about network support of an emergency service from a second terminal device; and determining, based on the information received from the first network node, whether a request for the emergency service from the second terminal device is compliant with a local regulation and an operator policy of a serving network of the first terminal device. With the method and device of the present disclosure, a mechanism is provided to apply the local regulation and operator policy of the Relay UE's serving PLMN regarding emergency service to the Remote UE.

WO

### TECHNICAL FIELD

The present disclosure generally relates to the field of emergency service handling, and more particularly to methods and devices for emergency service handling in User Equipment (UE) to network relaying.

### BACKGROUND

This section introduces aspects that may facilitate better understanding of the present disclosure. Accordingly, the statements of this section are to be read in this light and are not to be understood as admissions about what is in the prior art or what is not in the prior art.

In 5GS (5^{th} Generation System) proximity-based services (ProSe), a 5G ProSe-enabled User Equipment (UE) is defined as a UE that supports 5G ProSe requirements and associated procedures. A 5G ProSe UE-to-Network Relay is a type of 5G ProSe-enabled UE that provides functionality to support connectivity to the network for 5G ProSe Remote UE(s) that communicate with a DN (Data Network) via the 5G ProSe UE-to-Network Relay.

### 5G ProSe Layer-3 UE-to-Network Relay Reference Architecture

FIG. 1 shows a high-level reference architecture for 5G ProSe Layer-3 UE-to-Network Relay. In FIG. 1, the 5G ProSe Layer-3 UE-to-Network Relay may be in the HPLMN (Home Public Land Mobile Network) or a VPLMN (Visited Public Land Mobile Network).

FIG. 2 shows a non-roaming reference architecture for 5G ProSe Layer-3 UE-to-Network Relay when N3IWF (Non-3GPP (3th Generation Partnership Project) InterWorking Function) is supported. In FIG. 2, PLMN A and PLMN B may be the same or different. When the 5G ProSe Layer-3 Remote UE may connect to NG-RAN (Next Generation—Radio Access Network) directly to access PLMN B, it would take the role of UE in FIG. 2. The N3IWF may be connected to Relay UE UPF (User Plane Function) via a Data Network.

FIG. 3 shows a roaming reference architecture for 5G ProSe Layer-3 UE-to-Network Relay when the N3IWF is supported. In FIG. 3, PLMN A and PLMN B may be the same or different and/or PLMN A and PLMN C may be the same or different. The N3IWF may be connected to Relay UE UPF via a Data Network.

### 5G ProSe Layer-2 UE-to-Network Relay Reference Architecture

For 5G ProSe Layer-2 UE-to-Network Relaying, the serving PLMNs of the Remote UE and the Relay UE may be different when the NG-RAN is shared.

FIG. 4 shows a 5G ProSe Layer-2 UE-to-Network Relay reference architecture. The 5G ProSe Layer-2 Remote UE and the 5G ProSe Layer-2 UE-to-Network Relay may be served by the same or different PLMNs. If the serving PLMNs of the 5G ProSe Layer-2 Remote UE and the 5G ProSe Layer-2UE-to-Network Relay are different, then the NG-RAN is shared by the serving PLMNs (see the 5G MOCN architecture in clause 5.18 of TS 23.501).

It should be noted that Uu between the 5G ProSe Layer-2 Remote UE and the NG-RAN consists of RRC (Radio Resource Control), SDAP (Service Data Adaptation Protocol) and PDCP (Packet Data Convergence Protocol), and that the 5G ProSe Layer-2 Remote UE and the 5G ProSe Layer-2 UE-to-Network Relay are served by the same NG-RAN. The Core Network entities (e.g., AMF (Access and Mobility Management Function), SMF (Session Management Function), UPF) serving the 5G ProSe Layer-2 Remote UE and the 5G ProSe Layer-2 UE-to-Network Relay can be the same or different.

### UE Registration procedure

The Registration procedure for UE is performed as defined in TS 23.502 clause 4.2.2.2 with the following additions:
The UE includes the 5G ProSe Capability as part of the “5GMM (5GS Mobility Management) capability” in the Registration Request message. The AMF stores the 5G ProSe Capability for 5G ProSe operation.
   The 5G ProSe Capability indicates whether the UE supports one or more of the following ProSe capabilities:
      5G ProSe Direct Discovery;
      5G ProSe Direct Communication;
      5G ProSe Layer-2 UE-to-Network Relay;
      5G ProSe Layer-3 UE-to-Network Relay;
      5G ProSe Layer-2 Remote UE; and
      5G ProSe Layer-3 Remote UE.
The AMF obtains the 5G ProSe subscription data as part of the user subscription data from UDM (Unified Data Management) during UE Registration procedure using Nudm_SDM service as defined in clause 4.2.2.2.2 of TS 23.502.
The AMF determines whether the UE is authorized to use 5G ProSe services based on UE's 5G ProSe Capability and the ProSe Service Authorization included in the subscription data received from UDM as specified in clause 5.7. ProSe NR (New Radio) UE-PC5-AMBR(Aggregated Maximum Bit Rate) is also provided to the AMF as part of the subscription data for 5G ProSe services. The AMF stores the authorized 5G ProSe Capability.
The AMF sends the authorized 5G ProSe Capability for 5G ProSe operation to PCF (Policy Control Function). Based on the received 5G ProSe Capability from the AMF, the PCF provides the PC5 QoS parameters for 5G ProSe to AMF. The AMF stores such information as part of the UE context.
If the UE is authorized to use 5G ProSe services, then the AMF shall include in a NGAP message sent to NG-RAN:
   “5G ProSe authorized” information, including one or more of the following:
      whether the UE is authorized to use 5G ProSe Direct Discovery;
      whether the UE is authorized to use 5G ProSe Direct Communication;
      whether the UE is authorized to act as a 5G ProSe Layer-2 UE-to-Network Relay;
      whether the UE is authorized to act as a 5G ProSe Layer-3 UE-to-Network Relay;
      whether the UE is authorized to act as a 5G ProSe Layer-2 Remote UE.
   ProSe NR UE-PC5-AMBR, used by NG-RAN for the resource management of UE's PC5 transmission for 5G ProSe services in network scheduled mode.
   the PC5 QoS parameters for 5G ProSe used by the NG-RAN for the resource management of UE's PC5 transmission for ProSe services in network scheduled mode.
If the UE is authorized to use 5G ProSe services, then the AMF should not initiate the release of the signalling connection after the completion of the Registration procedure. The release of the signalling connection relies on the decision of NG-RAN, as specified in TS 23.502.

### SUMMARY

The present disclosure provides methods and devices for emergency service handling in UE-to-Network relaying.

According to a first aspect of the present disclosure, a method implemented by a first terminal device is provided. The method comprises: receiving, from a first network node, information about network support of an emergency service from a second terminal device; and determining, based on the information received from the first network node, whether a request for the emergency service from the second terminal device is compliant with a local regulation and an operator policy of a serving network of the first terminal device.

In an alternative embodiment of the first aspect, the first terminal device may be in an allowed area or in a non-allowed area.

In another alternative embodiment of the first aspect, the step of determining whether the request is compliant with the local regulation and the operator policy of the serving network of the first terminal device may comprise:
checking the network support of the emergency service from the second terminal device.

In still another alternative embodiment of the first aspect, in the case that the first terminal device and the second terminal device are served by different serving networks, the first terminal device may be prioritized by the serving network of the first terminal device.

According to a second aspect of the present disclosure, a method implemented by a first network node is provided. The method comprises: during a normal registration by a first terminal device, providing network support of an emergency service from a second terminal device in the case that the first terminal device is authorized to use a relay service; and transmitting information about the network support to the first terminal device.

According to a third aspect of the present disclosure, a method implemented by a second network node is provided. The method comprises: receiving, from a first network node, a list of serving networks of second terminal devices that have agreement with serving networks of a first terminal device; and receiving a radio resource control connection from a second terminal device; determining whether a serving network of the second terminal device is in the list; and in the case that the serving network of the second terminal device is not in the list, rejecting an emergency service request from the second terminal device.

According to a fourth aspect of the present disclosure, a first terminal device is provided. The first terminal device comprises a processor and a memory communicatively coupled to the processor. The memory is adapted to store instructions which, when executed by the processor, cause the first terminal device to perform operations of the method according to the above first aspect.

According to a fifth aspect of the present disclosure, a first terminal device is provided. The first terminal device is adapted to perform the method of the above first aspect.

According to a sixth aspect of the present disclosure, a first network node is provided. The first network node comprises a processor and a memory communicatively coupled to the processor. The memory is adapted to store instructions which, when executed by the processor, cause the first network node to perform operations of the method according to the above second aspect.

According to a seventh aspect of the present disclosure, a first network node is provided. The first network node is adapted to perform the method of the above second aspect.

According to an eighth aspect of the present disclosure, a second network node is provided. The second network node comprises a processor and a memory communicatively coupled to the processor. The memory is adapted to store instructions which, when executed by the processor, cause the second network node to perform operations of the method according to the above third aspect.

According to a ninth aspect of the present disclosure, a second network node is provided. The second network node is adapted to perform the method of the above third aspect.

According to a tenth aspect of the present disclosure, a wireless communication system is provided. The wireless communication system comprises: a first terminal device of the above fourth or fifth aspect; a first network node of the above sixth or seventh aspect, communicating with at least the first terminal device; and a second network node of the above eighth or ninth aspect, communicating with at least the first network node.

According to an eleventh aspect of the present disclosure, a non-transitory computer readable medium having a computer program stored thereon is provided. When the computer program is executed by a set of one or more processors of a first terminal device, the computer program causes the first terminal device to perform operations of the method according to the above first aspect.

According to a twelfth aspect of the present disclosure, a non-transitory computer readable medium having a computer program stored thereon is provided. When the computer program is executed by a set of one or more processors of a first network node, the computer program causes the first network node to perform operations of the method according to the above second aspect.

According to a thirteenth aspect of the present disclosure, a non-transitory computer readable medium having a computer program stored thereon is provided. When the computer program is executed by a set of one or more processors of a second network node, the computer program causes the second network node to perform operations of the method according to the above third aspect.

With the method and device of the present disclosure, a mechanism is provided to apply the local regulation and operator policy of the Relay UE's serving PLMN regarding emergency service to the Remote UE.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 is a schematic diagram illustrating a reference architecture for 5G ProSe Layer-3 UE-to-Network Relay;

FIG. 2 is a schematic diagram illustrating a non-roaming architecture model for 5G ProSe Layer-3 UE-to-Network Relay with N3IWF support;

FIG. 3 is a schematic diagram illustrating a roaming architecture model for 5G ProSe Layer-3 UE-to-Network Relay with N3IWF support;

FIG. 4 is a schematic diagram illustrating a 5G ProSe Layer-2 UE-to-Network Relay reference architecture;

FIG. 5 is a sequence diagram illustrating a Layer-2 link establishment procedure;

FIG. 6 is a flow chart illustrating a method implemented on a first terminal device according to some embodiments of the present disclosure;

FIG. 7 is a flow chart illustrating a method implemented on a first network node according to some embodiments of the present disclosure;

FIG. 8 is a flow chart illustrating a method implemented on a second network node according to some embodiments of the present disclosure;

FIG. 9 is a block diagram illustrating a first terminal device according to some embodiments of the present disclosure;

FIG. 10 is another block diagram illustrating a first terminal device according to some embodiments of the present disclosure;

FIG. 11 is a block diagram illustrating a first network node according to some embodiments of the present disclosure;

FIG. 12 is another block diagram illustrating a first network node according to some embodiments of the present disclosure;

FIG. 13 is a block diagram illustrating a second network node according to some embodiments of the present disclosure;

FIG. 14 is another block diagram illustrating a second network node according to some embodiments of the present disclosure;

FIG. 15 is a block diagram illustrating a wireless communication system according to some embodiments of the present disclosure;

FIG. 16 is a block diagram schematically illustrating a telecommunication network connected via an intermediate network to a host computer;

FIG. 17 is a generalized block diagram of a host computer communicating via a base station with a user equipment over a partially wireless connection; and

FIGS. 18 to 21 are flowcharts illustrating methods implemented in a communication system including a host computer, a base station and a user equipment.

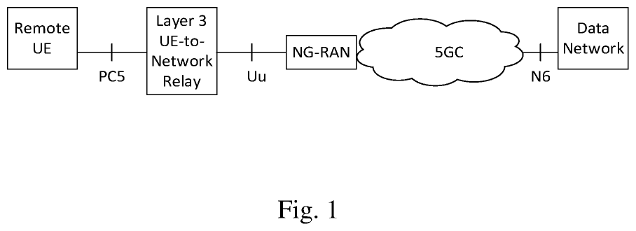

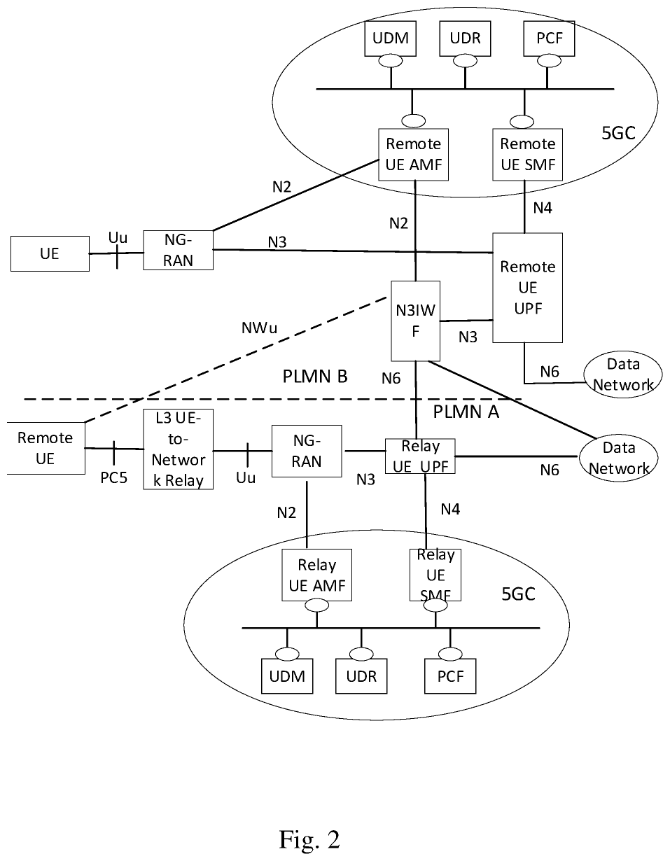

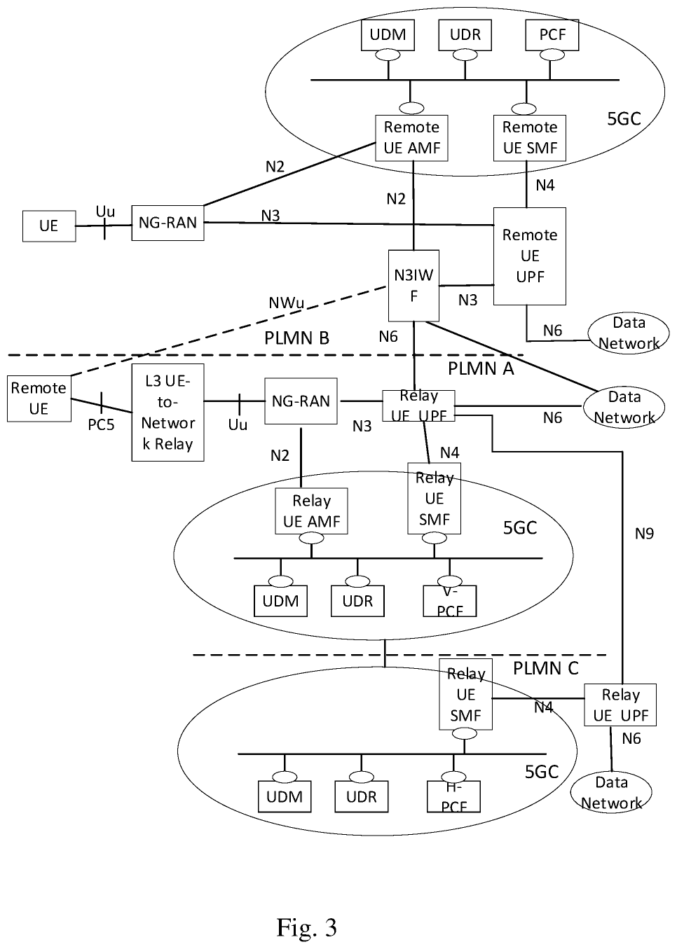

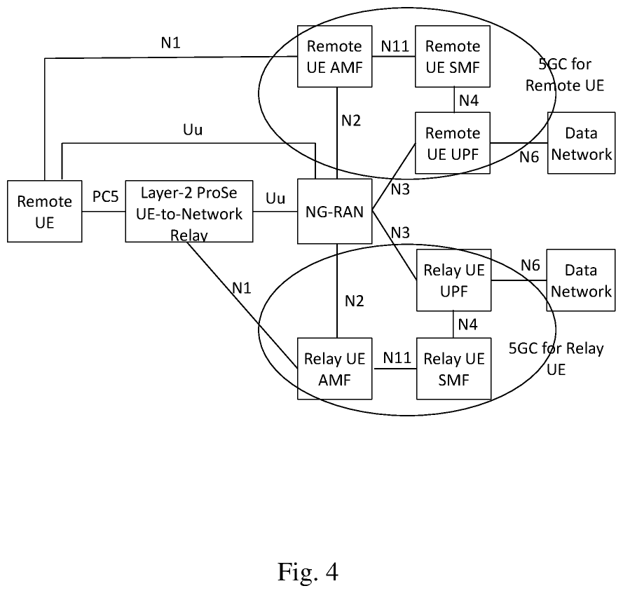

### DETAILED DESCRIPTION

The following detailed description describes methods and devices for methods and devices for emergency service handling in UE-to-Network relaying. In the following detailed description, numerous specific details such as logic implementations, types and interrelationships of system components, etc. are set forth in order to provide a more thorough understanding of the present disclosure. It should be appreciated, however, by one skilled in the art that the present disclosure may be practiced without such specific details. In other instances, control structures, circuits and instruction sequences have not been shown in detail in order not to obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals-such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

### Layer-2 Link Establishment Over PC5 Reference Point

To perform unicast mode of ProSe Direct communication over PC5 reference point, the UE is configured with the related information as described in clause 5.1.3 of TS 23.304 v17.3.0.

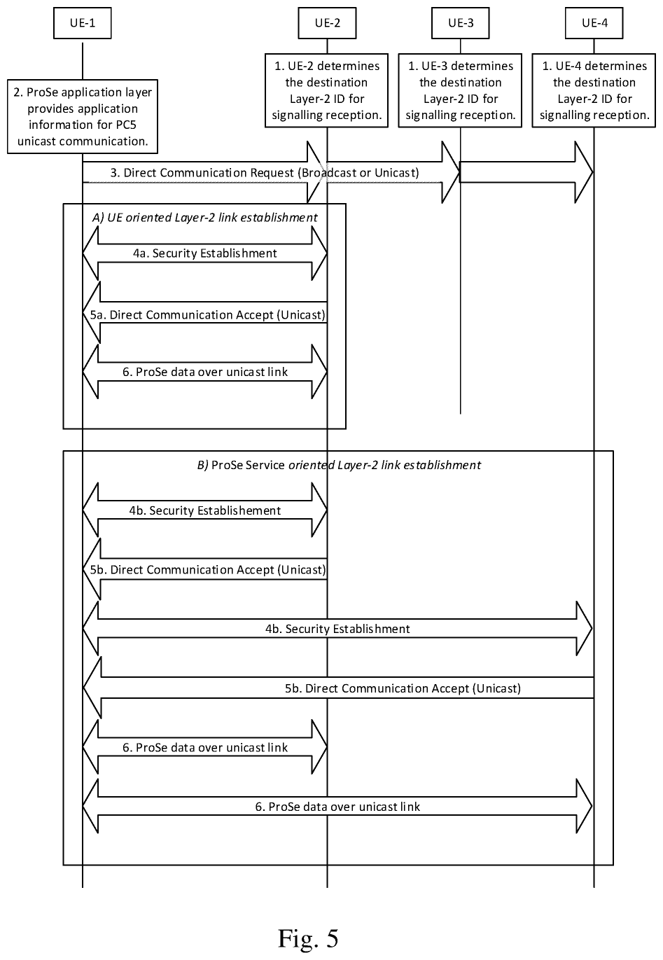

FIG. 5 shows a layer-2 link establishment procedure for the unicast mode of ProSe Direct communication over PC5 reference point.

At step 1, the UE(s) determine the destination Layer-2 ID for signalling reception for PC5 unicast link establishment as specified in clause 5.8.2.4 of TS 23.304 v17.3.0.

At step 2, the ProSe application layer in UE-1 provides application information for PC5 unicast communication. The application information includes the ProSe Service Info, UE's Application Layer ID. The target UE's Application Layer ID may be included in the application information. The ProSe application layer in UE-1 may provide ProSe Application Requirements for this unicast communication. UE-1 determines the PC5 QoS (Quality of Service) parameters and PFI (PC5 QoS Flow Identifier) as specified in clause 5.6.1 of TS 23.304 v17.3.0.

If UE-1 decides to reuse the existing PC5 unicast link as specified in clause 5.3.4 of TS 23.304 v17.3.0, the UE triggers the Layer-2 link modification procedure as specified in clause 6.4.3.4 of TS 23.304 v17.3.0. At step 3, UE-1 sends a Direct Communication Request message to initiate the unicast layer-2 link establishment procedure. The Direct Communication Request message includes:
Source User Info: the initiating UE's Application Layer ID (i.e. UE-1's Application Layer ID).
If the ProSe application layer provided the target UE's Application Layer ID in step 2, the following information is included:
   Target User Info: the target UE's Application Layer ID (i.e. UE-2's Application Layer ID).
ProSe Service Info: the information about the ProSe identifier(s) requesting Layer-2 link establishment.
Security Information: the information for the establishment of security.

The source Layer-2 ID and destination Layer-2 ID used to send the Direct Communication Request message are determined as specified in clauses 5.8.2.1 and 5.8.2.4 of TS 23.304 v17.3.0. The destination Layer-2 ID may be broadcast or unicast Layer-2 ID. When unicast Layer-2 ID is used, the Target User Info shall be included in the Direct Communication Request message.

UE-1 sends the Direct Communication Request message via PC5 broadcast or unicast using the source Layer-2 ID and the destination Layer-2 ID.

A default PC5 DRX (Discontinuous Reception) configuration may be used for transmitting and receiving of this message.

4. Security with UE-1 is established as below:
4a. If the Target User Info is included in the Direct Communication Request message, the target UE, i.e. UE-2, responds by establishing the security with UE-1.
4b. If the Target User Info is not included in the Direct Communication Request message, the UEs that are interested in using the announced ProSe Service(s) over a PC5 unicast link with UE-1 responds by establishing the security with UE-1.

When the security protection is enabled, UE-1 sends the following information to the target UE:
If IP communication is used:
   IP Address Configuration: For IP communication, IP address configuration is required for this link and indicates one of the following values:
      “DHCPv4 (Dynamic Host Configuration Protocol version 4) server” if only IPv4 (Internet Protocol version 4) address allocation mechanism is supported by the initiating UE, i.e., acting as a DHCPv4 server; or
      “IPv6 Router” if only IPv6 address allocation mechanism is supported by the initiating UE, i.e., acting as an IPV6 Router; or
      “DHCPv4 server & IPv6 Router” if both IPv4 and IPV6 address allocation mechanism are supported by the initiating UE; or
      “address allocation not supported” if neither IPv4 nor IPv6 address allocation mechanism is supported by the initiating UE.
   Link-Local IPv6 Address: a link-local IPv6 address formed locally based on RFC 4862 if UE-1 does not support the IPV6 IP address allocation mechanism, i.e. the IP Address Configuration indicates“address allocation not supported”.
QoS Info: the information about PC5 QoS Flow(s). For each PC5 QoS Flow, the PFI and the corresponding PC5 QoS parameters (i.e. PQI (PC5 QoS Identifier) and conditionally other parameters such as MFBR(Maximum Flow Bit Rate)/GFBR(Guaranteed Flow Bit Rate), etc.) and optionally the associated ProSe identifier(s).
Optional PC5 QoS Rule(s).

The source Layer-2 ID used for the security establishment procedure determined as specified in clauses 5.8.2.1 and 5.8.2.4 of TS 23.304 v17.3.0. The destination Layer-2 ID is set to the source Layer-2 ID of the received Direct Communication Request message.

Upon receiving the security establishment procedure messages, UE-1 obtains the peer UE's Layer-2 ID for future communication, for signalling and data traffic for this unicast link.

At step 5, a Direct Communication Accept message is sent to UE-1 by the target UE(s) that has successfully established security with UE-1:
5a. (UE oriented Layer-2 link establishment) If the Target User Info is included in the Direct Communication Request message, the target UE, i.e. UE-2 responds with a Direct Communication Accept message if the Application Layer ID for UE-2 matches.
5b. (ProSe Service oriented Layer-2 link establishment) If the Target User Info is not included in the Direct Communication Request message, the UEs that are interested in using the announced ProSe Service(s) respond to the request by sending a Direct Communication Accept message (UE-2 and UE-4 in FIG. 5).

The Direct Communication Accept message includes:
Source User Info: Application Layer ID of the UE sending the Direct Communication Accept message.
QoS Info: the information about PC5 QoS Flow(s). For each PC5 QOS Flow, the PFI and the corresponding PC5 QoS parameters requested by UE-1 (i.e. PQI and conditionally other parameters such as MFBR/GFBR, etc.) and optionally the associated ProSe identifiers(s).
Optional PC5 QoS Rule(s).
If IP communication is used:
   IP Address Configuration: For IP communication, IP address configuration is required for this link and indicates one of the following values:
      “DHCPv4 server” if only IPV4 address allocation mechanism is supported by the target UE, i.e., acting as a DHCPv4 server; or
      “IPv6 Router” if only IPv6 address allocation mechanism is supported by the target UE, i.e., acting as an IPv6 Router; or
      “DHCPv4 server & IPv6 Router” if both IPv4 and IPv6 address allocation mechanism are supported by the target UE; or
      “address allocation not supported” if neither IPv4 nor IPv6 address allocation mechanism is supported by the target UE.
   Link-Local IPv6 Address: a link-local IPv6 address formed locally based on RFC 4862 if the target UE does not support the IPv6 IP address allocation mechanism, i.e. the IP Address Configuration indicates “address allocation not supported”, and UE-1 included a link-local IPv6 address in the Direct Communication Request message. The target UE shall include a non-conflicting link-local IPv6 address.

If both UEs (i.e. the initiating UE and the target UE) are selected to use link-local IPv6 address, they shall disable the duplicate address detection defined in RFC 4862.

It should be noted that when either the initiating UE or the target UE indicates the support of IPv6 routing, the corresponding address configuration procedure would be carried out after the establishment of the layer 2 link, and the link-local IPv6 addresses are ignored.

The ProSe layer of the UE that established PC5 unicast link passes the PC5 Link Identifier assigned for the unicast link and the PC5 unicast link related information down to the AS (Access Stratum) layer. The PC5 unicast link related information includes Layer-2 ID information (i.e. source Layer-2 ID and destination Layer-2 ID). This enables the AS layer to maintain the PC5 Link Identifier together with the PC5 unicast link related information.

Two UEs may negotiate the PC5 DRX configuration in the AS layer, and the PC5 DRX parameter values can be configured per pair of source and destination Layer-2 IDs in the AS layer.

At step 6, ProSe data is transmitted over the established unicast link as below:

The PC5 Link Identifier and PFI are provided to the AS layer, together with the ProSe data.

Optionally in addition, the Layer-2 ID information (i.e. source Layer-2 ID and destination Layer-2 ID) is provided to the AS layer.

It should be noted that it is up to UE implementation to provide the Layer-2 ID information to the AS layer.

UE-1 sends the ProSe data using the source Layer-2 ID (i.e. UE-1's Layer-2 ID for this unicast link) and the destination Layer-2 ID (i.e. the peer UE's Layer-2 ID for this unicast link).

It should be noted that PC5 unicast link is bi-directional, therefore the peer UE of UE-1 can send the ProSe data to UE-1 over the unicast link with UE-1.

### Emergency Service Support in 5GS and EPS (Evolved Packet System)

Per TS 23.401 and TS 23.501, depending on local regulation and an operator's policy, the MME (Mobility Management Entity) may support emergency service for UEs as follows:
a. Valid UEs only.
b. Only UEs that are authenticated are allowed
c. IMSI (International Mobile Subscriber Identity) required, authentication optional.
d. All UEs are allowed.

### Emergency Services

Emergency Services are provided to support IMS emergency sessions. “Emergency Services” refer to functionalities provided by the serving network when the network is configured to support Emergency Services. Emergency Services are provided to normally registered UEs and to Emergency Registered UEs, that can be either normally registered or in limited service state. Depending on local regulation, receiving Emergency Services in limited service state does not require a valid subscription. Depending on local regulation and on operator's policy, the network may allow or reject a registration request for Emergency Services (i.e. Emergency Registration) from UEs that have been identified to be in limited service state. Four different behaviors of Emergency Services as defined in clause 4.3.12.1 of TS 23.401 are supported.

### IMS Emergency Session Support

IMS Emergency Session provides an overview about functionality for emergency bearer services. This overview applies to eCall Over IMS unless stated otherwise. The specific functionality is described in the affected procedures and functions of this specification.

Emergency bearer services are provided to support IMS emergency sessions. Emergency bearer services are functionalities provided by the serving network when the network is configured to support emergency services. Emergency bearer services are provided to normal attached or emergency attached UEs and depending on local regulation, to UEs that are in limited service state. Receiving emergency services in limited service state does not require a subscription. Depending on local regulation and an operator's policy, the MME may allow or reject an emergency attach request for UEs in limited service state. Four different behaviors of emergency bearer support have been identified as follows:
a. Valid UEs only. No limited service state UEs are supported in the network. Only UEs that have a valid subscription, are authenticated and authorized for PS service in the attached location are allowed. UEs should be attached to the network and then perform a PDN (Packet Data Network) Connection Request when an IMS emergency session is detected by the UE.
b. Only UEs that are authenticated are allowed. These UEs must have a valid IMSI. These UEs are authenticated and may be in limited service state due to being in a location that they are restricted from service. A UE that cannot be authenticated will be rejected.
c. IMSI required, authentication optional. These UEs must have an IMSI. If authentication fails, the UE is granted access and the unauthenticated IMSI retained in the network for recording purposes. The IMEI (International Mobile Equipment Identity) is used in the network as the UE identifier. IMEI only UEs will be rejected (e.g., UICCless UEs).
d. All UEs are allowed. Along with authenticated UEs, this includes UEs with an IMSI that cannot be authenticated and UEs with only an IMEI. If an unauthenticated IMSI is provided by the UE, the unauthenticated IMSI is retained in the network for recording purposes. The IMEI is used in the network to identify the UE.

### Support of Emergency for UE-to-Network Relaying

According to TS 22.101, emergency service is defined as citizen to authority services, and it is left to the national authorities to decide whether the network accepts emergency calls e.g. for valid UE only, or for UEs without the SIM/USIM/ISIM (Subscriber Identity Module/Universal Subscriber Identity Module/International Mobile Subscriber Identity).

In the 5G ProSe UE-to-Network relaying, if there is an emergency request from the remote UE, it implies that the Relay UE needs to be responsible for remote UE's emergency service.

Assuming that a UE relaying emergency service for another UE is compliant with local regulation, it is needed to address whether and how to address the following aspects for 5G ProSe UE-to-Network Relaying:
Whether and how the UE-to Network Relay identifies the emergency services from the Remote UE and vice versa;
Under which conditions can it be ensured that the emergency call is routed to PSAP of the same country as the Remote UE;
What are UE and network behaviors and principles of operation for a Remote UE and 5G ProSe UE-to-Network Relay to be enhanced for the emergency services, below are some (but not limited) aspects:
   Overriding Mobility Restrictions when applicable as defined in TS 23.501.
   Supporting emergency services in Limited service state as defined in clause 5.16.4 of TS 23.501.
   Supporting Congestion Control as defined in clause 5.19 of TS 23.501.

### Emergency Services for UE to Network Relaying

The solution disclosed herein addresses Support of Emergency Services for UE to Network Relaying.

Under the assumptions that a UE responsible for another UE's emergency service is compliant with local regulation and the Relay UE and the Remote UE belong to the same PLMN, this solution disclosed herein contains the following aspects:
Provisioning emergency service support
A 5G ProSe UE-to-Network Relay advertises its support of emergency service only when the UE receives emergency support indication in Registration Accept.
A 5G ProSe Remote UE becomes aware whether a 5G ProSe UE-to-Network Relay can support emergency services during discovery.
A 5G ProSe Remote UE indicates emergency access request to the 5G ProSe UE-to-Network Relay during PC5 link establishment, and 5G ProSe UE-to-Network Relay informs its network (both Radio and Core) of the emergency service.
If the 5G ProSe Remote UE completes the emergency call, it may wait for a configurable period of time before initiating release of PC5 link for emergency service. This is to prepare for any possible call back.
When the PC5 link for emergency service is released, for Layer-2 UE-to-Network relaying, if the 5G ProSe UE-to-Network Relay is not involved in emergency service from any remote UE, the relay UE informs the AMF to remove the emergency indication.

### Procedures

Policy/Parameter provisioning for 5G ProSe UE-to-Network Relay
Mobility Restrictions for 5G ProSe UE-to-Network Relaying, reflecting the support of emergency service
ProSe UE-to-Network Relay Discovery
ProSe Communication via 5G ProSe Layer-3 UE-to-Network Relay without N3IWF
ProSe Communication via 5G ProSe Layer-3 UE-to-Network Relay with N3IWF support
5G ProSe Communication via 5G ProSe Layer-2 UE-to-Network Relay, in which:
   If the 5G ProSe UE-to-Network Relay UE's state is in RRC_IDLE, then the Relay UE set RRC establishment cause to “emergency”.
   If the 5G ProSe UE-to-Network Relay UE's state is in RRC_CONNECTED, the 5G ProSe UE-to-Network Relay needs to inform its CN over NAS that the UE is involved in emergency service for a 5G ProSe UE-to-Network Remote UE, so that the 5G ProSe UE-to-Network Relay UE can be exempted from e.g., overload control.

For emergency service from the 5G ProSe Remote UE, it may not be possible to apply the local regulation and operator policy of the Relay UE's serving PLMN to the Remote UE. Below are some examples of how the Relay UE's serving network's local regulation can apply to the Remote UE:
If the 5G ProSe UE-to-Network Relay UE's serving PLMN supports emergency service from UEs with IMSI, then the emergency service from a 5G ProSe Remote UE without IMSI being present is to be rejected;
If the Relay UE's serving PLMN supports emergency service from UEs with IMSI but authentication optional, then the Relay may skip the security procedure for 5G ProSe Communication via 5G ProSe Layer-3 UE-to-Network Relay.

Moreover, for Layer 2 UE-to-Network Relaying, when the serving PLMNs of the L2 Remote UE and Relay UE are different, there is no mechanism for the Relay UE's serving PLMN to have some control whether the emergency service from the Remote UE (being served by another PLMN) should be allowed.

In this regard, The UE Registration procedure may be enhanced as follows:

In the case of a 5G ProSe enabled UE, if the UE is authorized to act as a Relay, the AMF may provide information about the network support of emergency service for Remote UE as follows:
IMSI required, authentication optional;
IMSI required, authentication required; or
All UEs allowed (with or without IMSI)

As to whether the UE has an IMSI, this is detected by whether the Remote UE provides a PRUK ID (ProSe Remote User Key Identifier) or SUCI (Subscription Concealed Identifier) to the Relay UE.

The provided information about the network support of emergency service may also include:
Only Remote UEs served by the same PLMN required.

For Layer-2 5G ProSe UE-to-Network Relaying:
The AMF may send, to the NG-RAN in an NGAP (NG Application Protocol) message (e.g. INITIAL CONTEXT SETUP REQUEST), a list of the Remote UE's serving PLMN(s) that have agreement with Relay UE's PLMN.
When the Layer-2 Remote UE establishes its RRC Connection to the NG-RAN, the NG-RAN may determine whether the Remote UE's serving PLMN is in the list that has agreement with the Relay UE's PLMN. If Remote UE's serving PLMNs do not have agreement with the Relay UE's PLMN, the NG-RAN may reject the emergency service request.

Furthermore, During Layer-2 link establishment over PC5 reference point for 5G ProSe UE-to-Network Relay:
the Remote UE may need to tell the Relay UE if it has an IMSI (which may be possible currently if the Remote UE sends a PRUK ID or SUCI in Direct Communication Request to the Relay UE);
the Relay UE will check its serving network's support of emergency service for Remote UE as follows:
   If the Relay UE's network requires the IMSI, then an emergency service from SIM-less Remote UE may not be allowed.
   If the Relay UE's network does not require authentication of Remote UE, then the Relay UE may skip the procedure for Security for 5G ProSe Communication via 5G ProSe UE-to-Network Relay.
   For Layer-2 UE-to-Network Relaying, if the Remote UE has a different serving PLMN but the Relay UE's serving network does not allow an emergency service from Remote UE with a different serving PLMN, the emergency service from the Remote UE will be rejected with a proper cause so that the Remote UE will choose the same serving PLMN as the Relay UE.

The Above Disclosure of the Solution May Be Enhanced in at Least the following aspects:

When a 5G ProSe enabled UE acts as Relay, based on the SA1 response, the Relay UE may have a normal registration in the network. The UE may be in Allowed Area or in Non-Allowed Area.

For Remote UE without a SIM/USIM/ISIM being present, the local regulation and operator policy of the Relay UE's serving PLMN may apply to the Remote UE as well.

Under the assumption that the local regulation and operator policy of the Relay UE's serving PLMN will apply to the Remote UE as well, in order to allow the 5G ProSe UE-to-Network Relay to determine as early as possible whether the Remote UE's emergency request is compliant with the local regulation and operator policy of the Relay UE's serving PLMN:
During Registration from a 5G ProSe enabled UE, if the UE is authorized to act as a Relay, the AMF may provide the network support of emergency service for Remote UE as follows:
IMSI required, authentication required;
IMSI required, authentication optional; or
All UEs are allowed.

When a UE with Relay capability (also known as “Relay enabled UE”) performs a normal registration, the AMF may check if the Relay service is authorized (e.g. by means of the AMF checking subscription data from UDM, local configuration. If it is authorized, the AMF may provide the information about the network support for the emergency service from a remote UE.
When the Remote UE sets up the PC5 link for emergency service towards the Relay UE, the Relay UE may need to check the network support of emergency service for Remote UE.
Depending on the network support of emergency service for Remote UE, the Relay UE may reject the Layer-2 link establishment request, or may skip the procedure for Security for 5G ProSe Communication via 5G ProSe UE-to-Network Relay. During PC5 Layer-2 link establishment, the Relay UE will check also the AMF provided network support of remote UE emergency service when determining whether to reject the link establishment, or continue the link establishment but skip the security procedure for 5G ProSe Communication via 5G ProSe Layer-3 UE-to-Network Relay.

For Layer-2 5G ProSe UE-to-Network relaying, if the Remote UE and the Relay UE are served by different PLMNs (i.e. RAN is shared by multiple PLMNs), in order to avoid dropping of emergency service from the L2 Remote UE, there may be an implication that the Layer 2 Relay UE needs to be prioritized by its serving network which is different from the Remote UE's serving network.

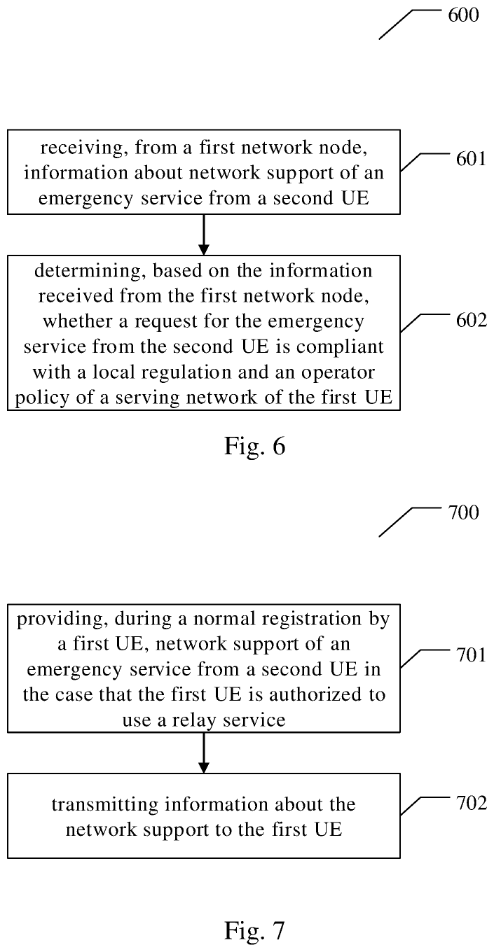

FIG. 6 is a flow chart illustrating a method 600 implemented on a first terminal device according to some embodiments of the present disclosure. As an example, operations of this flow chart may be performed by a Relay enabled UE throughout the context, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the first terminal device may receive, from a first network node, information about network support of an emergency service from a second terminal device (block 601). The first terminal device may then determine, based on the information received from the first network node, whether a request for the emergency service from the second terminal device is compliant with a local regulation and an operator policy of a serving network of the first terminal device (block 602). As an example, the second terminal device may be a Remote UE, and the first network node may be an AMF.

As an example, the first terminal device may be in an allowed area or in a non-allowed area.

As an example, the step of determining whether the request is compliant with the local regulation and the operator policy of the serving network of the first terminal device may comprise:
checking the network support of the emergency service from the second terminal device.

As a further example, the information about the network support may include at least:
IMSI of the second terminal device required and authentication of the second terminal device required;
IMSI of the second terminal device required and authentication of the second terminal device optional; or
all of second terminal devices being allowed.

As a still further example, the information about the network support may further include at least:
only the second terminal devices served by the same serving network as the first terminal device being allowed.

As a further example, the checking of the network support may comprise:
in response to the IMSI being required, rejecting the emergency service from a second terminal device without the IMSI;
in response to the authentication being optional, continuing the emergency service and skipping a security procedure for communication via the first terminal device; or
rejecting the emergency service from a second terminal device having a different serving network from the first terminal device

As an example, in the case that the first terminal device and the second terminal device are served by different serving networks, the first terminal device may be prioritized by the serving network of the first terminal device.

Furthermore, the present disclosure provides a first terminal device which is adapted to perform the method 600.

FIG. 7 is a flow chart illustrating a method 700 implemented on a first network node according to some embodiments of the present disclosure. As an example, operations of this flow chart may be performed by an AMF.

In one embodiment, the first network node may provide, during a normal registration by a first terminal device, network support of an emergency service from a second terminal device in the case that the first terminal device is authorized to use a relay service (block 701). The first network node may then transmit information about the network support to the first terminal device (block 702). As an example, the first terminal device may be a Relay enabled UE, and the second terminal device may be a Remote UE.

As an example, the information about the network support may include at least:
IMSI of the second terminal device required and authentication of the second terminal device required;
IMSI of the second terminal device required and authentication of the second terminal device optional; or
all of second terminal devices being allowed.

As a further example, the information about the network support may further include at least:
only the second terminal devices served by the same serving network as the first terminal device being allowed.

As an example, the method 700 may further comprise:
transmitting, to a second network node, a list of serving networks of the second terminal devices that have agreement with serving networks of the first terminal device.

Furthermore, the present disclosure provides a first network node which is adapted to perform the method 700.

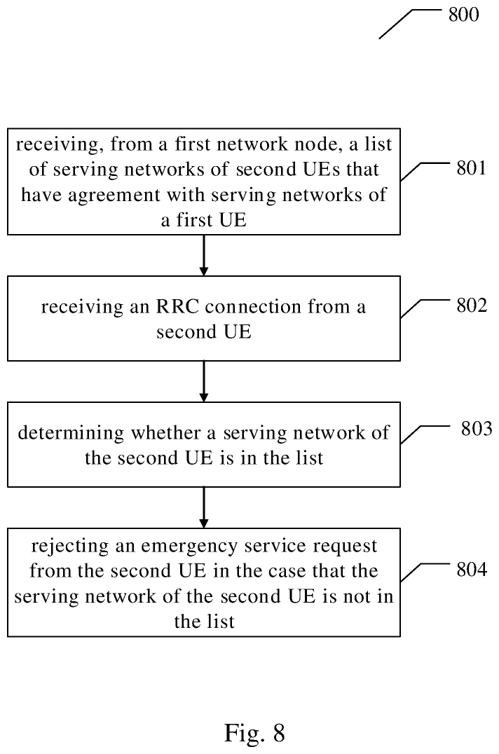

FIG. 8 is a flow chart illustrating a method 800 implemented on a second network node according to some embodiments of the present disclosure. As an example, operations of this flow chart may be performed by an NG-RAN.

In one embodiment, the second network node may receive, from a first network node, a list of serving networks of second terminal devices that have agreement with serving networks of a first terminal device (block 801). The second network node may receive an RRC connection from a second terminal device (block 802). The second network node may determine whether a serving network of the second terminal device is in the list (block 803). Then, in the case that the serving network of the second terminal device is not in the list, the second network node may reject an emergency service request from the second terminal device (block 804). As an example, the first network node may be an AMF, the first terminal device may be a Relay enabled UE, and the second terminal device may be a Remote UE.

Furthermore, the present disclosure provides a second network node which is adapted to perform the method 800.

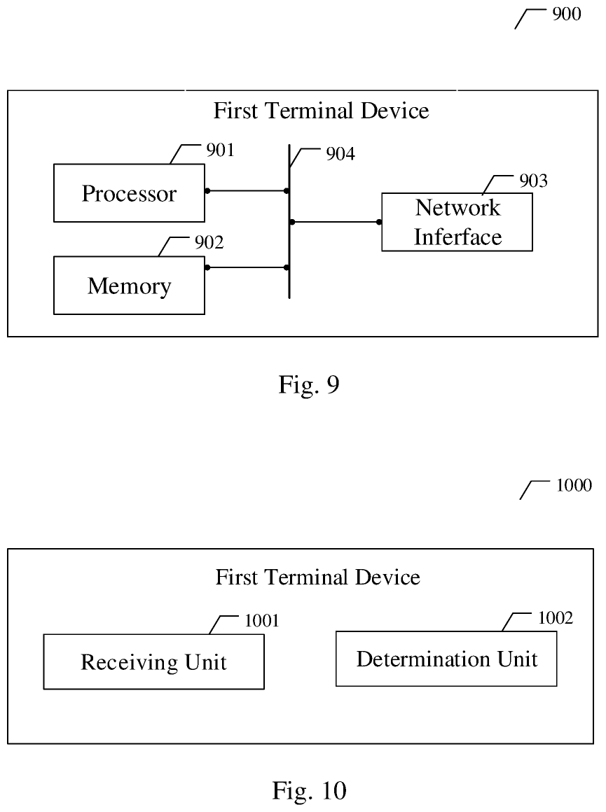

FIG. 9 is a block diagram illustrating a first terminal device 900 according to some embodiments of the present disclosure. As an example, the first terminal device 900 may act as a Relay enabled UE, but it is not limited thereto. It should be appreciated that the first terminal device 900 may be implemented using components other than those illustrated in FIG. 9.

With reference to FIG. 9, the first terminal device 900 may comprise at least a processor 901, a memory 902, a network interface 903 and a communication medium 904. The processor 901, the memory 902 and the network interface 903 may be communicatively coupled to each other via the communication medium 904.

The processor 901 may include one or more processing units. A processing unit may be a physical device or article of manufacture comprising one or more integrated circuits that read data and instructions from computer readable media, such as the memory 902, and selectively execute the instructions. In various embodiments, the processor 901 may be implemented in various ways. As an example, the processor 901 may be implemented as one or more processing cores. As another example, the processor 901 may comprise one or more separate microprocessors. In yet another example, the processor 901 may comprise an application-specific integrated circuit (ASIC) that provides specific functionality. In still another example, the processor 901 may provide specific functionality by using an ASIC and/or by executing computer-executable instructions.

The memory 902 may include one or more computer-usable or computer-readable storage medium capable of storing data and/or computer-executable instructions. It should be appreciated that the storage medium is preferably a non-transitory storage medium.

The network interface 903 may be a device or article of manufacture that enables the first terminal device 900 to send data to or receive data from other devices. In different embodiments, the network interface 903 may be implemented in different ways. As an example, the network interface 903 may be implemented as an Ethernet interface, a token-ring network interface, a fiber optic network interface, a network interface (e.g., Wi-Fi, WiMax, etc.), or another type of network interface.

The communication medium 904 may facilitate communication among the processor 901, the memory 902 and the network interface 903. The communication medium 904 may be implemented in various ways. For example, the communication medium 904 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 9, the instructions stored in the memory 902 may include those that, when executed by the processor 901, cause the first terminal device 900 to implement the method described with respect to FIG. 6.

FIG. 10 is another block diagram illustrating a first terminal device 1000 according to some embodiments of the present disclosure. As an example, the first terminal device 1000 may act as a Relay enabled UE, but it is not limited thereto. It should be appreciated that the first terminal device 1000 may be implemented using components other than those illustrated in FIG. 10.

With reference to FIG. 10, the first terminal device 1000 may comprise at least a receiving unit 1001 and a determination unit 1002. The receiving unit 1001 may be adapted to perform at least the operations described in the block 601 of FIG. 6. The determination unit 1002 may be adapted to perform at least the operation described in the block 602 of FIG. 6.

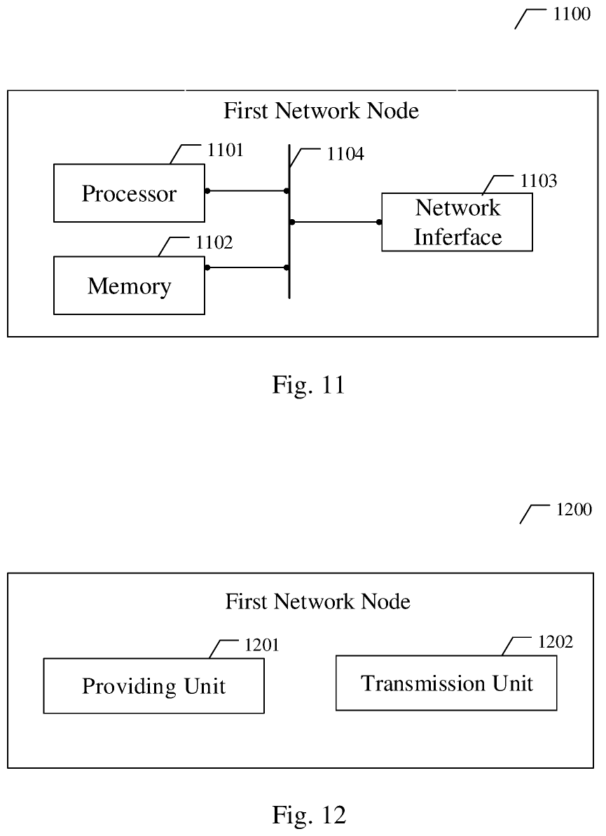

FIG. 11 is a block diagram illustrating a first network node 1100 according to some embodiments of the present disclosure. As an example, the first network node 1100 may act as an AMF. It should be appreciated that the first network node 1100 may be implemented using components other than those illustrated in FIG. 11.

With reference to FIG. 11, the first network node 1100 may comprise at least a processor 1101, a memory 1102, a network interface 1103 and a communication medium 1104. The processor 1101, the memory 1102 and the network interface 1103 are communicatively coupled to each other via the communication medium 1104.

The processor 1101, the memory 1102, the network interface 1103 and the communication medium 1104 are structurally similar to the processor 901, the memory 902, the network interface 903 and the communication medium 904 respectively, and will not be described herein in detail.

In the example of FIG. 11, the instructions stored in the memory 1102 may include those that, when executed by the processor 1101, cause the first network node 1100 to implement the method described with respect to FIG. 7.

FIG. 12 is another block diagram illustrating a first network node 1200 according to some embodiments of the present disclosure. As an example, the first network node 1200 may act as an AMF, but it is not limited thereto. It should be appreciated that the first network node 1200 may be implemented using components other than those illustrated in FIG. 12.

With reference to FIG. 12, the first network node 1200 may comprise at least a providing unit 1201 and a transmission unit 1202. The providing unit 1201 may be adapted to perform at least the operation described in the block 701 of FIG. 7. The transmission unit 1202 may be adapted to perform at least the operation described in the block 702 of FIG. 7.

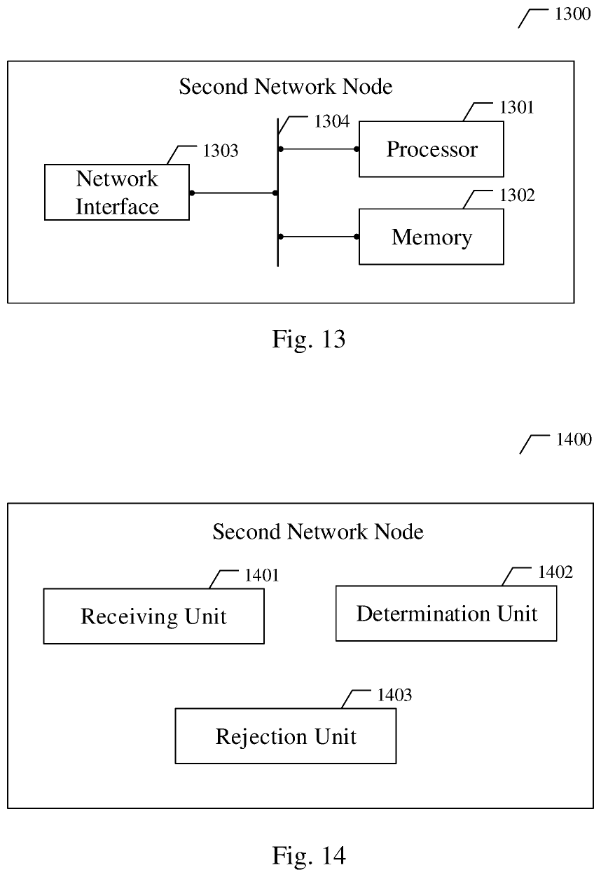

FIG. 13 is a block diagram illustrating a second network node 1300 according to some embodiments of the present disclosure. As an example, the second network node 1300 may act as an NG-RAN, but it is not limited thereto. It should be appreciated that the second network node 1300 may be implemented using components other than those illustrated in FIG. 13.

With reference to FIG. 13, the second network node 1300 may comprise at least a processor 1301, a memory 1302, a network interface 1303 and a communication medium 1304. The processor 1301, the memory 1302 and the network interface 1303 are communicatively coupled to each other via the communication medium 1304.

The processor 1301, the memory 1302, the network interface 1303 and the communication medium 1304 are structurally similar to the processor 901 or 1101, the memory 902 or 1102, the network interface 903 or 1103 and the communication medium 904 or 1104 respectively, and will not be described herein in detail.

In the example of FIG. 13, the instructions stored in the memory 1302 may include those that, when executed by the processor 1301, cause the second network node 1300 to implement the method described with respect to FIG. 8.

FIG. 14 is another block diagram illustrating a second network node 1400 according to some embodiments of the present disclosure. As an example, the second network node 1400 may provide act as an NG-RAN, but it is not limited thereto. It should be appreciated that the second network node 1400 may be implemented using components other than those illustrated in FIG. 14.

With reference to FIG. 14, the second network node 1400 may comprise at least a receiving unit 1401, a determination unit 1402 and a rejection unit 1403. The receiving unit 1401 may be adapted to perform at least the operations described in the blocks 801 and 802 of FIG. 8. The determination unit 1402 may be adapted to perform at least the operation described in the block 803 of FIG. 8. The rejection unit 1403 may be adapted to perform at least the operation described in the block 804 of FIG. 8.

The units shown in FIGS. 10, 12 and 14 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 6-8.

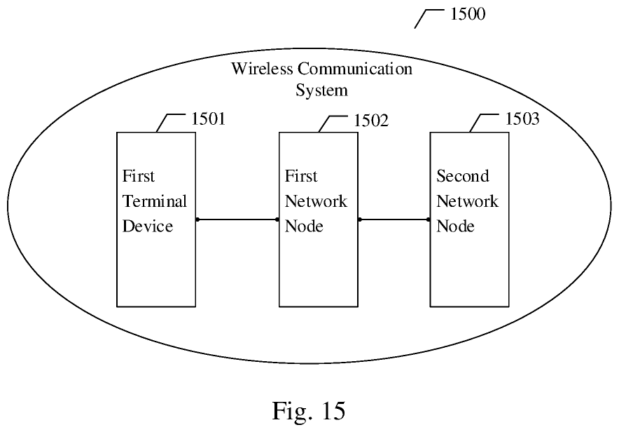

FIG. 15 is a block diagram illustrating a wireless communication system 1500 according to some embodiments of the present disclosure. The wireless communication system 1500 comprises at least a first terminal device 1501, a first network node 1502 and a second network node 1503. In one embodiment, the first terminal device 1501 may act as the first terminal device 900 or 1000 as depicted in FIG. 9 or 10, the first network node 1502 may act as the first network node 1100 or 1200 as depicted in FIG. 11 or 12, and the second network node 1503 may act as the second network node 1300 or 1400 as depicted in FIG. 13 or 14. In one embodiment, the first terminal device 1501 and the second network node 1503 may communicate with the first network node 1502.

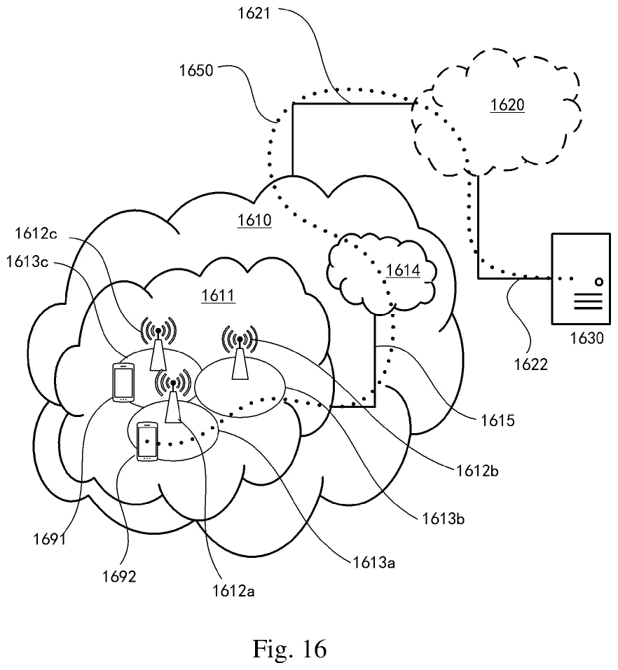

FIG. 16 is a block diagram schematically illustrating a telecommunication network connected via an intermediate network to a host computer.

With reference to FIG. 16, in accordance with an embodiment, a communication system includes a telecommunication network 1610, such as a 3GPP-type cellular network, which comprises an access network 1611, such as a radio access network, and a core network 1614. The access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to the core network 1614 over a wired or wireless connection 1615. A first user equipment (UE) 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

The telecommunication network 1610 is itself connected to a host computer 1630, which may be embodied in the hardware and/or software of a standalone server, a cloud-implemented server, a distributed server or as processing resources in a server farm. The host computer 1630 may be under the ownership or control of a service provider, or may be operated by the service provider or on behalf of the service provider. The connections 1621, 1622 between the telecommunication network 1610 and the host computer 1630 may extend directly from the core network 1614 to the host computer 1630 or may go via an optional intermediate network 1620. The intermediate network 1620 may be one of, or a combination of more than one of, a public, private or hosted network; the intermediate network 1620, if any, may be a backbone network or the Internet; in particular, the intermediate network 1620 may comprise two or more sub-networks (not shown).

The communication system of FIG. 16 as a whole enables connectivity between one of the connected UEs 1691, 1692 and the host computer 1630. The connectivity may be described as an over-the-top (OTT) connection 1650. The host computer 1630 and the connected UEs 1691, 1692 are configured to communicate data and/or signaling via the OTT connection 1650, using the access network 1611, the core network 1614, any intermediate network 1620 and possible further infrastructure (not shown) as intermediaries. The OTT connection 1650 may be transparent in the sense that the participating communication devices through which the OTT connection 1650 passes are unaware of routing of uplink and downlink communications. For example, a base station 1612 may not or need not be informed about the past routing of an incoming downlink communication with data originating from a host computer 1630 to be forwarded (e.g., handed over) to a connected UE 1691. Similarly, the base station 1612 need not be aware of the future routing of an outgoing uplink communication originating from the UE 1691 towards the host computer 1630.

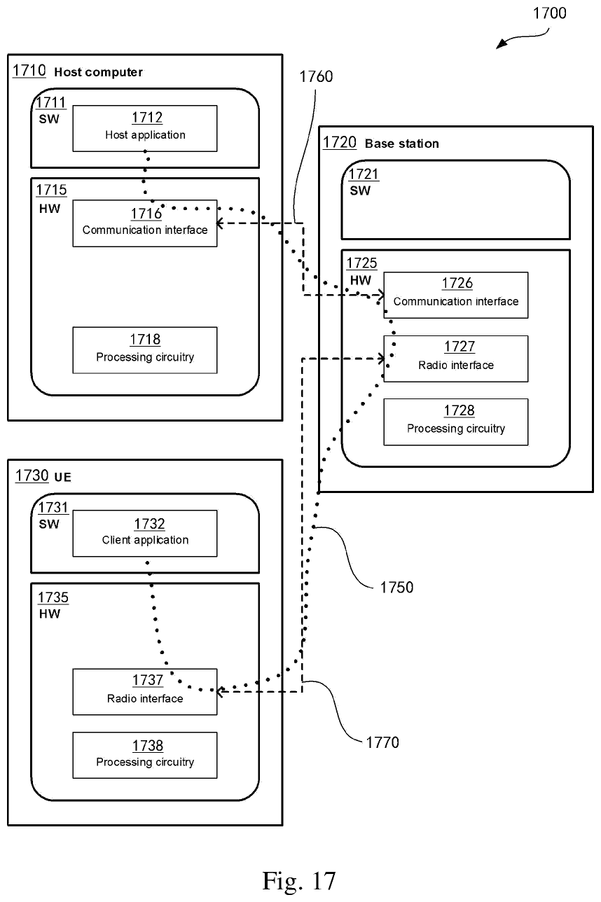

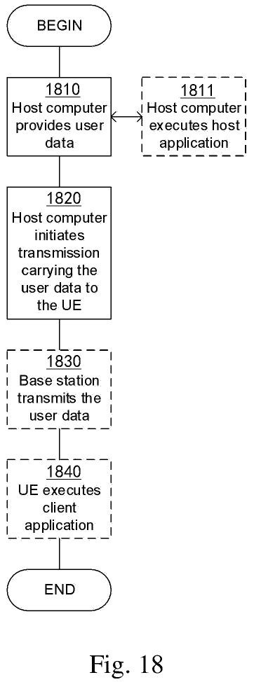

Example implementations, in accordance with an embodiment, of the UE, base station and host computer discussed in the preceding paragraphs will now be described with reference to FIG. 17. In a communication system 1700, a host computer 1710 comprises hardware 1715 including a communication interface 1716 configured to set up and maintain a wired or wireless connection with an interface of a different communication device of the communication system 1700. The host computer 1710 further comprises processing circuitry 1718, which may have storage and/or processing capabilities. In particular, the processing circuitry 1718 may comprise one or more programmable processors, application-specific integrated circuits, field programmable gate arrays or combinations of these (not shown) adapted to execute instructions. The host computer 1710 further comprises software 1711, which is stored in or accessible by the host computer 1710 and executable by the processing circuitry 1718. The software 1711 includes a host application 1712. The host application 1712 may be operable to provide a service to a remote user, such as a UE 1730 connecting via an OTT connection 1750 terminating at the UE 1730 and the host computer 1710. In providing the service to the remote user, the host application 1712 may provide user data which is transmitted using the OTT connection 1750.

The communication system 1700 further includes a base station 1720 provided in a telecommunication system and comprising hardware 1725 enabling it to communicate with the host computer 1710 and with the UE 1730. The hardware 1725 may include a communication interface 1726 for setting up and maintaining a wired or wireless connection with an interface of a different communication device of the communication system 1700, as well as a radio interface 1727 for setting up and maintaining at least a wireless connection 1770 with a UE 1730 located in a coverage area (not shown in FIG. 17) served by the base station 1720. The communication interface 1726 may be configured to facilitate a connection 1760 to the host computer 1710. The connection 1760 may be direct or it may pass through a core network (not shown in FIG. 17) of the telecommunication system and/or through one or more intermediate networks outside the telecommunication system. In the embodiment shown, the hardware 1725 of the base station 1720 further includes processing circuitry 1728, which may comprise one or more programmable processors, application-specific integrated circuits, field programmable gate arrays or combinations of these (not shown) adapted to execute instructions. The base station 1720 further has software 1721 stored internally or accessible via an external connection.

The Communication System 1700 Further Includes the Ue 1730 already referred to. Its hardware 1735 may include a radio interface 1737 configured to set up and maintain a wireless connection 1770 with a base station serving a coverage area in which the UE 1730 is currently located. The hardware 1735 of the UE 1730 further includes processing circuitry 1738, which may comprise one or more programmable processors, application-specific integrated circuits, field programmable gate arrays or combinations of these (not shown) adapted to execute instructions. The UE 1730 further comprises software 1731, which is stored in or accessible by the UE 1730 and executable by the processing circuitry 1738. The software 1731 includes a client application 1732. The client application 1732 may be operable to provide a service to a human or non-human user via the UE 1730, with the support of the host computer 1710. In the host computer 1710, an executing host application 1712 may communicate with the executing client application 1732 via the OTT connection 1750 terminating at the UE 1730 and the host computer 1710. In providing the service to the user, the client application 1732 may receive request data from the host application 1712 and provide user data in response to the request data. The OTT connection 1750 may transfer both the request data and the user data. The client application 1732 may interact with the user to generate the user data that it provides.

It is noted that the host computer 1710, base station 1720 and UE 1730 illustrated in FIG. 17 may be identical to the host computer 1630, one of the base stations 1612a, 1612b, 1612c and one of the UEs 1691, 1692 of FIG. 16, respectively. This is to say, the inner workings of these entities may be as shown in FIG. 17 and independently, the surrounding network topology may be that of FIG. 16.

In FIG. 17, the OTT connection 1750 has been drawn abstractly to illustrate the communication between the host computer 1710 and the use equipment 1730 via the base station 1720, without explicit reference to any intermediary devices and the precise routing of messages via these devices. Network infrastructure may determine the routing, which it may be configured to hide from the UE 1730 or from the service provider operating the host computer 1710, or both. While the OTT connection 1750 is active, the network infrastructure may further take decisions by which it dynamically changes the routing (e.g., on the basis of load balancing consideration or reconfiguration of the network).

The wireless connection 1770 between the UE 1730 and the base station 1720 is in accordance with the teachings of the embodiments described throughout this disclosure. One or more of the various embodiments improve the performance of OTT services provided to the UE 1730 using the OTT connection 1750, in which the wireless connection 1770 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1750 between the host computer 1710 and UE 1730, in response to variations in the measurement results. The measurement procedure and/or the network functionality for reconfiguring the OTT connection 1750 may be implemented in the software 1711 of the host computer 1710 or in the software 1731 of the UE 1730, or both. In embodiments, sensors (not shown) may be deployed in or in association with communication devices through which the OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of the OTT connection 1750 may include message format, retransmission settings, preferred routing etc. ; the reconfiguring need not affect the base station 1720, and it may be unknown or imperceptible to the base station 1720. Such procedures and functionalities may be known and practiced in the art. In certain embodiments, measurements may involve proprietary UE signaling facilitating the host computer's 1710 measurements of throughput, propagation times, latency and the like. The measurements may be implemented in that the software 1711, 1731 causes messages to be transmitted, in particular empty or ‘dummy’ messages, using the OTT connection 1750 while it monitors propagation times, errors etc.

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In a first step 1810 of the method, the host computer provides user data. In an optional substep 1811 of the first step 1810, the host computer provides the user data by executing a host application. In a second step 1820, the host computer initiates a transmission carrying the user data to the UE. In an optional third step 1830, the base station transmits to the UE the user data which was carried in the transmission that the host computer initiated, in accordance with the teachings of the embodiments described throughout this disclosure. In an optional fourth step 1840, the UE executes a client application associated with the host application executed by the host computer.

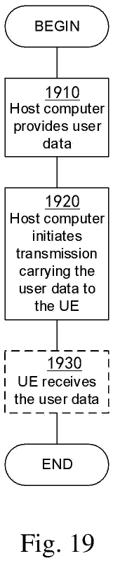

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In a first step 1910 of the method, the host computer provides user data. In an optional substep (not shown) the host computer provides the user data by executing a host application. In a second step 1920, the host computer initiates a transmission carrying the user data to the UE. The transmission may pass via the base station, in accordance with the teachings of the embodiments described throughout this disclosure. In an optional third step 1930, the UE receives the user data carried in the transmission.

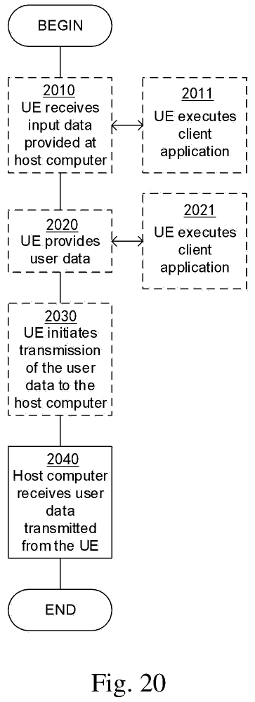

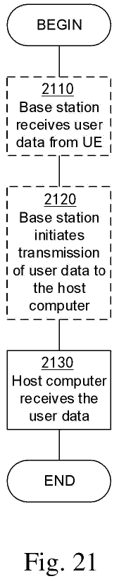

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 2010 of the method, the UE receives input data provided by the host computer. Additionally or alternatively, in an optional second step 2020, the UE provides user data. In an optional substep 2021 of the second step 2020, the UE provides the user data by executing a client application. In a further optional substep 2011 of the first step 2010, the UE executes a client application which provides the user data in reaction to the received input data provided by the host computer. In providing the user data, the executed client application may further consider user input received from the user. Regardless of the specific manner in which the user data was provided, the UE initiates, in an optional third substep 2030, transmission of the user data to the host computer. In a fourth step 2040 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 2110 of the method, in accordance with the teachings of the embodiments described throughout this disclosure, the base station receives user data from the UE. In an optional second step 2120, the base station initiates transmission of the received user data to the host computer. In a third step 2130, the host computer receives the user data carried in the transmission initiated by the base station.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1-25. (canceled)

26. A method implemented by a first terminal device, the method comprising:
receiving, from a first network node, information about network support of an emergency service from a second terminal device; and
determining, based on the information received from the first network node, whether a request for the emergency service from the second terminal device is compliant with a local regulation and an operator policy of a serving network of the first terminal device.

27. The method of claim 26, wherein the first terminal device is in an allowed area or in a non-allowed area.

28. The method of claim 26, wherein the step of determining whether the request is compliant with the local regulation and the operator policy of the serving network of the first terminal device comprises:
checking the network support of the emergency service from the second terminal device.

29. The method of claim 28, wherein the information about the network support includes at least:
International Mobile Subscriber Identity (IMSI) of the second terminal device required and authentication of the second terminal device required;
IMSI of the second terminal device required and authentication of the second terminal device optional; or
all of second terminal devices being allowed.

30. The method of claim 29, wherein the information about the network support further includes at least:
only the second terminal devices served by the same serving network as the first terminal device being allowed.

31. The method of claim 29, wherein the checking of the network support comprises:
in response to the IMSI being required, rejecting the emergency service from a second terminal device without the IMSI;
in response to the authentication being optional, continuing the emergency service and skipping a security procedure for communication via the first terminal device; or
rejecting the emergency service from a second terminal device having a different serving network from the first terminal device.

32. The method of claim 26, wherein in the case that the first terminal device and the second terminal device are served by different serving networks, the first terminal device is prioritized by the serving network of the first terminal device.

33. The method of claim 26, wherein the first terminal device is a relay enabled terminal device, the second terminal device is a remote terminal device, and the first network node is an Access and Mobility Management Function.

34. A method implemented by a first network node, the method comprising:
during a normal registration by a first terminal device, providing network support of an emergency service from a second terminal device in the case that the first terminal device is authorized to use a relay service; and
transmitting information about the network support to the first terminal device.

35. The method of claim 34, wherein the information about the network support includes at least:
International Mobile Subscriber Identity (IMSI) of the second terminal device required and authentication of the second terminal device required;
IMSI of the second terminal device required and authentication of the second terminal device optional; or
all of second terminal devices being allowed.

36. The method of claim 35, wherein the information about the network support further includes at least:
only the second terminal devices served by the same serving network as the first terminal device being allowed.

37. The method of claim 34, further comprising:
transmitting, to a second network node, a list of serving networks of the second terminal devices that have agreement with serving networks of the first terminal device.

38. The method of claim 34, wherein the first network node is an Access and Mobility Management Function, the first terminal device is a relay enabled terminal device, and the second terminal device is a remote terminal device.

39. A method implemented by a second network node, the method comprising:
receiving, from a first network node, a list of serving networks of second terminal devices that have agreement with serving networks of a first terminal device; and
receiving a radio resource control connection from a second terminal device;
determining whether a serving network of the second terminal device is in the list; and
in the case that the serving network of the second terminal device is not in the list, rejecting an emergency service request from the second terminal device.

40. The method of claim 39, wherein the second network node is a Next Generation Radio Access Network, the first network node is an Access and Mobility Management Function, the first terminal device is a relay enabled terminal device, and the second terminal device is a remote terminal device.

41. A first terminal device, comprising:
a processor; and
a memory communicatively coupled to the processor and adapted to store instructions which, when executed by the processor, cause the first terminal device to perform operations of the method of claim 26.

42. A first network node, comprising:
a processor; and
a memory communicatively coupled to the processor and adapted to store instructions which, when executed by the processor, cause the first network node to perform operations of the method of claim 34.

43. A second network node, comprising:
a processor; and
a memory communicatively coupled to the processor and adapted to store instructions which, when executed by the processor, cause the second network node to perform operations of the method of claim 39.

44. A wireless communication system, comprising:
a first terminal device, comprising a first processor and a first memory communicatively coupled to the first processor and configured to store first instructions;
a first network node, comprising a second processor and a second memory communicatively coupled to the second processor and configured to store second instructions; and
a second network node, comprising a third processor and a third memory communicatively coupled to the third processor and configured to store third instructions;
wherein the first instructions are configured to, when executed by the first processor, cause the first terminal device to receive, from the first network node, information about network support of an emergency service from a second terminal device and determine, based on the information received from the first network node, whether a request for the emergency service from the second terminal device is compliant with a local regulation and an operator policy of a serving network of the first terminal device;
wherein the second instructions are configured to, when executed by the second processor, cause the first network node to, during a normal registration by the first terminal device, provide network support of the emergency service from the second terminal device in the case that the first terminal device is authorized to use a relay service and transmitting information about the network support to the first terminal device; and
wherein the third instructions are configured to, when executed by the third processor, cause the second network node to receive, from the first network node, a list of serving networks of second terminal devices that have agreement with serving networks of the first terminal device, receive a radio resource control connection from the second terminal device, determine whether a serving network of the second terminal device is in the list, and, in the case that the serving network of the second terminal device is not in the list, reject an emergency service request from the second terminal device.
